(19) United States
(12) Patent Application Publication
(10) Pub. No.: US 2004/0037942 A1
(43) Pub. Date: Feb. 26, 2004

(54) Composition

(76) Inventor: Naina Kiran Shah, Lawrence, KS (US)

Correspondence Address: Colgate-Palmolive Company, 909 River Road, P.O. Box 1343, Piscataway, NJ, 08855-1343, US

(21) Appl. No.: 10/224,175

(22) Filed: Aug. 20, 2002

(51) Int. Cl. A23L 1/31

(52) U.S. Cl. 426/646

(57) ABSTRACT

A pet food composition which comprises a retortable diet having large quantities of moisture in admixture with a sufficient amount of psyllium to provide pet food in an essentially homogeneous mass after manufacturing.

### BACKGROUND OF THE INVENTION

Pet food packed in containers, such as cans, and having a relatively large amount of moisture have been available to pets, particularly canines and felines for many years. Such diets can provide a fully nutritious diet to the pet satisfying all its nutritional needs. In order to satisfy a nutrient profile the pet should eat a specific quantity of the diet on a daily basis. In order to accomplish this, the diet must be inter alia, aesthetically pleasing, palatable, and at least essentially homogeneous throughout—that is, each bite should have essentially the same nutrient composition throughout. In this manner, the pet is better assured in obtaining its complete nutritional needs. Where a diet is not essentially homogeneous throughout, for example layered, the pet can selectively eat certain portions while ignoring other portions, will no ingest a balanced diet and, therefore, not achieve a proper nutritional profile.

Diets with relatively large quantities of water, have a greater tendency to separate into phases and provide a non-homogeneous mass due to settling under gravitational force, and processing conditions which further facilitate phase separation e.g. centrifugal force.

A new method of establishing essentially homogeneity of a retortable pet food having large quantities of water has been established. This method involves the incorporation of psyllium into the pet food. The psyllium increases the raw product viscosity thereby preventing or substantially preventing the pet food from separating into various phases, particularly phases which are overly populated by water and/or grain.

### SUMMARY OF THE INVENTION

In accordance with the invention, there is a pet food composition which comprises a retortable diet having large quantities of moisture and meeting the dietary nutrient requirement of the pet in admixture with a sufficient amount of psyllium to provide the pet food in an essentially homogeneous mass after manufacturing.

A further aspect of the invention is a method for establishing the essential homogeneity of a retortable pet food diet having high quantities of water and meeting the dietary nutrient requirement of the animal which comprises adding diet homogeneity maintaining effective amounts of psyllium to the pet food prior to entry of the said pet food into a container which is then closed.

### DETAILED DESCRIPTION OF THE INVENTION

The diets involved in this invention generally involve using meat in its chunky state. Additionally, the carbohydrates are also in their particulate state, more natural, as opposed to a ground, mealy form. A method of preparing such a diet for cats is described in WO 02/00036 incorporated by reference. For canines, which generally require less protein and more carbohydrate, the same diet and preparatory procedures can be used as in the feline but the carbohydrate should be in their non-chemically altered state, that is they should be in their natural state or their physically altered state.

The diet nutritional composition will differ somewhat as to the object of the diet, dog or cat, but generally the meat content is from about 30 to about 60 wt. % of the diet for cats and 10 to about 35% for dogs, carbohydrates, often times in the form of grains, from about 4 to about 30 wt. %, fats in the range of about 2 to about 10 wt. %, and moisture, from all sources, in the range from about 65 to about 80 wt. %. The quantity of psyllium, generally in the form of fibrous husks or other fibrous, chunky form, is an amount effective to maintain at least essential physical homogeneity of the diet. In this manner, heavier particles are not at the bottom, and lighter particles (and fluid), do not rise to the top. Generally, from about 0.15, 0.20, 0.25, 0.35 or 0.5 wt. % of psyllium as measured by the diet is a minimum amount. With respect to a maximum quantity, generally no more than about 4 wt. %, preferably about 3, 2.5, 2, 1.5 or 1.0 wt. % of the diet is psyllium. Carbohydrate content includes psyllium.

Other materials such as minerals, vitamins and the like are also present in the usual quantities to meet the nutritional requirements of the pet, dog or cat, ingesting the diet.

Examples of meat which can be used in the diet include beef, pork, lamb, fish and the like.

Examples of carbohydrates include rice, barley, oat, corn, wheat and the like. Whole grain is preferred. Rice is also preferred.

Examples of fats include soybean oil, fish oil, chicken fat and the like.

### BRIEF DESCRIPTION OF FIGURES

FIG. 1 shows control product, no psyllium.

FIG. 2 shows product with 0.15 wt. % psyllium.

FIG. 3 shows product with 0.5 wt. % psyllium.

FIG. 4 shows control product out of inverted can, no psyllium.

FIG. 5 shows product out of inverted can, 0.5 wt. % psyllium.

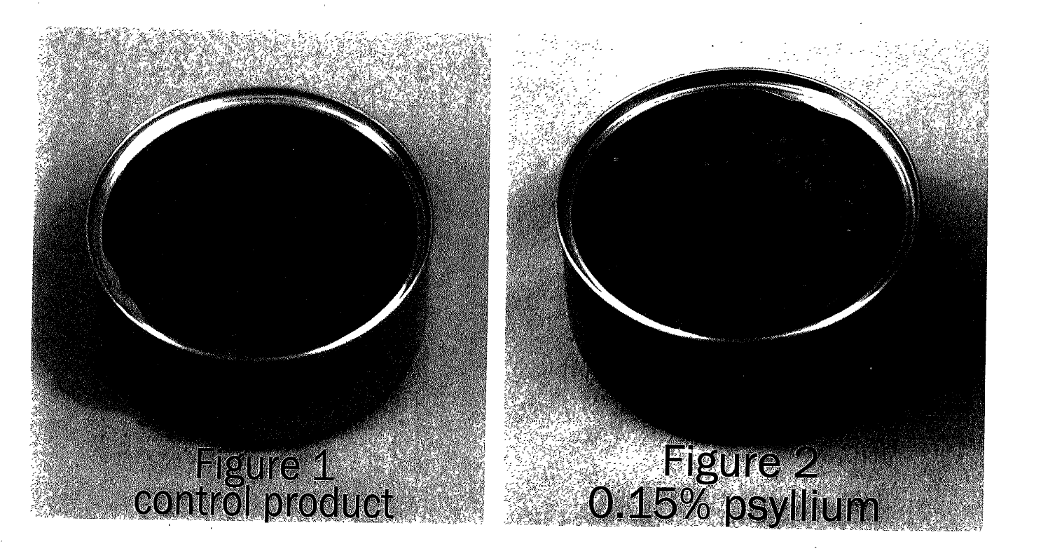

With reference to the figures, FIG. 1 shows the chunky meat product with no psyllium. Fluid is at the top as well as rice, the grain employed, particles.

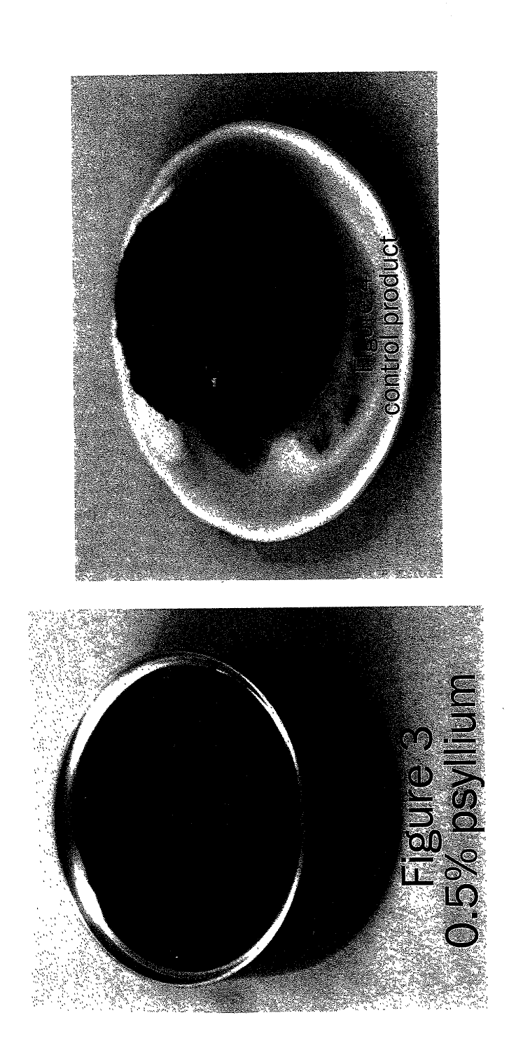

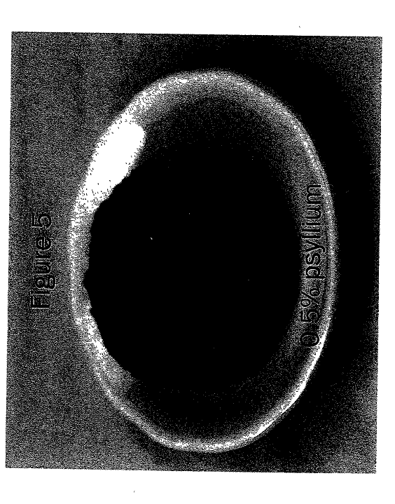

FIG. 2 shows the improvement with only 0.15 wt. % psyllium present. There is less fluid and rice present at the top. FIG. 3 shows the strong positive results when 0.5 wt. % psyllium is employed. A homogeneous diet is present. No fluid or rice particles are visibly present at the top. FIG. 4 shows the control diet out of the can while FIG. 5 shows the diet with 0.5 wt. % psyllium out of the can. The effect of an appropriate quantity of psyllium is demonstrated visually by these photographs in the Figures.

The presence of the psyllium in the diet prevents the settling of the grain during the manufacturing process, i.e., the canning of the wet diet, and promotes the binding of water and meat particles to give a more aesthetically pleasing product. Its mechanism of action appears to the increasing of the viscosity of the raw product, for example as measured by a Bostwick consistometer, the units expressed as distance traveled in cms/30sec, the product temperature averaged at 90+3° F. Raw, more viscous products travel less distance and better suspend particles so that they are particularly resistant to forces during the manufacturing process, for example a spinning action during the sealing of the can which can bring about phase separation of the particles (grain, such as rice).

Below are measurements of viscosity showing the decrease in distance traveled (viscosity increased) as more psyllium is added.

| Parameter | Control | Test 1 | Test 2 | Test 3 | Test 4 | Test 5 | Test 6 |
|---|---|---|---|---|---|---|---|
| % Psyllium | 0% | 0.15% | 0.3% | 0.5% | 0.7% | 1.0% | 1.5% |
| Product | 14 | 14 | 12.7 | 10 | 11.8 | 6.1 | 5.1 |
| Viscosity* | | | | | | | |
| Amount of Meat | 47 | 47 | 47 | 47 | 47 | 47 | 47 |
| Amount of Dry Mix | 12.6 | 12.6 | 12.6 | 12.6 | 12.6 | 12.6 | 12.7 |
| Amount of Rice | 4 | 4 | 3.9 | 3.7 | 3.5 | 3.3 | 2.9 |

*Product viscosity measured by Bostwick consistometer and expressed as distance traveled in cms/30 sec. Product temperature averaged at 90 ± 3° F.

During a manufacturing process, after the can is filled and sealed, it is turned upside down and is retorted in the same orientation. The product gets cooked during retorting setting the meat and grain to give a solid mass in this inverted position, the denser particles like rice grain that settled down are thus at the top of the can (right side up) making the product rather un-appealing when a consumer opens the can. This can be seen in FIG. 1, a non-homogeneous mass with a thick layer of grain at the top as well as the presence of visible free liquid.

In the FIGS. 1-5 and the test runs 1-6 showing the viscosity increase for the feline diets were comprised of about 13 wt. % dry mix (grains, starches, vitamins, fibers, mineral mixes, etc.) 47 wt. % meat and the remainder water. As the amount of psyllium was added, the amount of rice was reduced somewhat. Feline diets are the preferred diet.

1. A pet food composition which comprises a retortable diet having large quantities of meat and large quantity of moisture in admixture with a sufficient amount of psyllium to provide pet food in an essentially homogeneous mass after manufacturing.

2. The composition in accordance with claim 1 wherein there is about 30 to about 55 wt. % meat.

3. The composition in accordance with claim 1 wherein there is no more than about 3 wt. % psyllium in the diet.

4. The composition in accordance with claim 1 wherein the pet is a feline

5. A method for establishing the essential homogeneity of a retortable pet food diet having high quantities of meat and high quantities of water which comprises adding diet homogeneity maintaining effective amounts of psyllium of the pet food prior to entry of said pet food with a container which is then closed.

6. The method in accordance with claim 5 wherein there is about 30 to about 55 wt. % meat.

7. The method in accordance with claim 5 wherein there is no more than about 3 wt. % psyllium in the diet.

8. The method in accordance with claim 5 wherein the pet is a feline.
